(19) United States
(12) Patent Application Publication
(10) Pub. No.: US 2025/0196406 A1
(43) Pub. Date: Jun. 19, 2025

(54) MOLDING APPARATUS AND METHOD

(71) Applicant: Global Polymer Industries, Inc., Madison, SD (US)

(72) Inventor: Todd M. Huntimer, Arlington, SD (US)

(21) Appl. No.: 18/540,121

(22) Filed: Dec. 14, 2023

(51) Int. Cl. B29C 43/14; B29C 33/56; B29C 43/00; B29C 43/04; B29C 43/32; B29C 43/34; B29C 43/36; B29C 43/52; B29K 23/00; B29K 105/00

(52) U.S. Cl. CPC B29C 43/14; B29C 43/003; B29C 43/006; B29C 43/04; B29C 43/34; B29C 43/361; B29C 43/52; B29C 33/56; B29C 2043/046; B29C 2043/141; B29C 2043/3283; B29C 2043/3427; B29C 2043/3615; B29K 2023/0683; B29K 2105/251; B29K 2905/00

(57) ABSTRACT

Embodiments are directed to a compression molding apparatus. The compression molding apparatus may include a female mold, a heated male mold, and a cooled male mold. The female mold may carry ultra-high-molecular-weight polyethylene (“UHMW”) material. The heated male mold may compress the UHMW material in the female mold during a first time period. The cooled male mold may compress the UHMW material in the female mold during a second time period.

### FIELD OF THE INVENTION

This application relates to compression molding apparatuses and, more particularly, yet not exclusively, compression molding apparatuses for molding ultra-high-molecular-weight polyethylene.

### BACKGROUND OF THE INVENTION

Ultra-high-molecular-weight polyethylene (“UHMW” or “UHMW PE”) has an ultra-low melt index, typically a melt index of zero. Accordingly, UHMW cannot be transformed into a liquid. Instead, when UHMW is heated beyond its melting point (approximately 270° F.), it remains rubbery. Because UHMW cannot be transformed into a liquid, objects cannot be manufactured by injection molding with UHMW. Typically, ram extrusion or direct compression molding (“DCM”) processes are employed to manufacture objects with UHMW. Extrusion processes can be used to manufacture objects that have a fixed cross-sectional profile. DCM processes can be employed to manufacture objects with varying cross-sectional profiles. Compression molding can also be used with other materials, even if such materials do not have a melt index of zero.

Typical DCM techniques include “ramp and soak.” In the common ramp-and-soak technique used with UHMW PE, for example, the material resin in granular form is loaded by hand into a mold, the UHMW is heated past its melting point to 350-400° F., the UHMW is compressed while being heated in the mold to take the shape of the manufactured object, after which the UHMW part is cooled in the compressed mold. The typical DCM technique takes approximately 32 minutes to manufacture an object in a mold depending on the overall size and thickness as well as the intensity of the cooling. Typical DCM machines have four mold cavities and, accordingly, produce up to four UHMW PE objects every 32 minutes. Thus, it is with regard to these considerations and improving upon the manufacturing techniques that the present invention has been developed.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of the Preferred Embodiment, which is to be read in association with the accompanying drawings, wherein:

FIG. 1 is an isometric view of an example compression molding apparatus, with an example rotary shuttle;

FIG. 2 is an isometric view of a portion of the compression molding apparatus of FIG. 1;

FIG. 3 is an isometric view of a portion of the compression molding apparatus of FIG. 1 in a compression configuration, with UHMW granules being loaded into a lower mold at a first station;

FIG. 4 is an isometric view of a portion of the compression molding apparatus of FIG. 1 in a transition configuration, with the UHMW granules being moved to a second station and a completed UHMW product moved to the first station;

FIG. 5 is an isometric view of a portion of the compression molding apparatus of FIG. 1 in a compression configuration, with the completed UHMW product at the first station being secured for removal from the compression molding apparatus;

FIG. 6 is an isometric side view of an example slide dump assembly for loading UHMW granules into a lower mold at the first station of the compression molding apparatus of FIG. 1, with the slide dump assembly in a retracted configuration;

FIG. 7 is an isometric view of the slide dump assembly of FIG. 6 in impact configuration, as also shown in FIG. 1;

FIG. 8 is an isometric view of the slide dump assembly of FIG. 7 in a loading configuration;

FIG. 9 is an isometric view of another embodiment including a material feed assembly;

FIG. 10 is an exploded view of the apparatus of FIG. 9;

FIG. 11A is a side-elevational view of a slide dump assembly;

FIG. 11B is an exploded view of the assembly of FIG. 11A;

FIG. 12 is a perspective view of a portion of the molding apparatus showing the raw material feed assembly;

FIG. 13A is a perspective view of a portion of the molding apparatus showing the part removal;

FIG. 13B is an elevational view of the part gripper assembly; and

FIG. 14 is a perspective view of the molding apparatus showing a step in the part removal process.

### SUMMARY OF THE INVENTION

The following briefly describes example embodiments of the invention in order to provide a basic understanding of some aspects of the invention. This brief description is not intended as an extensive overview. It is not intended to identify key or critical elements or to delineate or otherwise narrow the scope. Its purpose is merely to present some concepts in a simplified form as a prelude to the more detailed description that is presented later.

Briefly stated, various embodiments are directed to a compression molding apparatus. In one or more of the various embodiments, the compression molding apparatus may include a female mold, a heated male mold, and a cooled male mold. In some of the various embodiments, the female mold may carry ultra-high-molecular-weight polyethylene (“UHMW”) material. In some embodiments, the heated male mold may compress the UHMW material in the female mold during a first time period. In some embodiments, the cooled male mold may compress the UHMW material in the female mold during a second time period.

Note that, depending on the form of the material placed into the molds, the male and female molds may be switched, or two male or two female molds may be used. In any case, for purposes of non-limiting example, a female mold will be described as being the lower mold while a male mold will be described as being the upper mold. Likewise, the molds do not necessarily have to be upper and lower, as they could be positioned in any orientation at any or all steps of the process.

In one or more of the various embodiments, a shuttle may move the female mold between the first time period and the second time period from a first compression/heating station at which the heated male mold is disposed to a second compression station at which the cooled male mold is disposed.

In some of the various embodiments, a shuttle elevator may raise the shuttle from a first elevation to a second elevation at which the shuttle is disposed while moving the female mold to the second station and may lower the shuttle from the second elevation to the first elevation when the female mold is positioned at the second station.

In one or more of the various embodiments, a second heated male mold may compress the UHMW material in the female mold during another time period (a “third” time period). In some of the various embodiments, the third time period may be after the first time period and before the second time period noted above. In other words, a second heating/compression stage may be employed between a first heating/compression stage and a first cooling/compression stage such that two successive heating/compression stages are employed before cooling.

In some embodiments, the second heated male mold may compress the UHMW material with a different pressure and/or temperature than the first heated male mold.

In one or more of the various embodiments, a second cooled male mold may compress the UHMW material in the female mold during another stage (such as a “third” time period). In some of the various embodiments, the third time period may be after the first time period and before the second time period. Thus, the process may involve one, two or more heating/compression stages and one, two, or more cooling/compression stages any of which may have various heat and compression levels applied.

In one or more of the various embodiments, the heated male mold may have an air poppet valve.

In one or more of the various embodiments, the cooled male mold may compress the UHMW material in the female mold for 10, 5, 4, 3, 2, or fewer minutes.

In one or more of the various embodiments, the heated male mold and the cooled male mold may be devoid of ejector pins.

In one or more of the various embodiments, the heated male mold may include steel. In one or more of the various embodiments, the female mold may include aluminum.

In one or more of the various embodiments, a slide dump assembly may have a bed that holds raw material granules (such as UHMW PE) and that slides over the female mold while depositing granules in the female mold. Such depositing of material may be accomplished in a single load or multiple loads to spread the material within the mold as desired for the shape of the part to be molded.

In one or more of the various embodiments, a slide dump assembly may have a bed, a gate, and a drive. In some of the various embodiments, the bed may have a lower opening and may hold granules. In some embodiments, the gate may transition between blocking and unblocking the lower opening. In some embodiments, the drive may move the bed from a retracted configuration to a loading configuration. In some embodiments, the lower opening of the bed in the loading configuration may be disposed over the female mold. In some embodiments, the gate may block the lower opening in the retracted configuration and may unblock the lower opening in the loading configuration to facilitate the granules flowing through the lower opening into the female mold when the bed is in the loading configuration. In some preferred embodiments, an air drive may open the gate to deliver the granules to the female mold at a pre-programmed location. Multiple locations may be programmed for a single or multiple delivery.

In some embodiments, the gate may be biased to block the lower opening. In some embodiments, the gate may have a tab. In some embodiments, the drive may move the bed from a retracted configuration to a loading configuration. In some embodiments, the lower opening of the bed in the loading configuration may be disposed over the female mold. In some embodiments, the gate may block the lower opening in the retracted configuration. In some embodiments, the tab of the gate may contact a component of the compression molding apparatus when the bed is in the loading configuration and may cause the gate to unblock the lower opening to facilitate the raw material granules flowing through the lower opening into the female mold when the bed is in the loading configuration.

Also briefly stated, various embodiments are directed to a compression molding method. In one or more of the various embodiments, UHMW PE material may be deposited into a female mold. In some of the various embodiments, the UHMW material in the female mold may be compressed with a heated male mold during a first time period. In some embodiments, the UHMW material in the female mold may be compressed with a cooled male mold during a second time period.

In one or more of the various embodiments, the female mold may be moved with a shuttle from a first station at which the heated male mold is disposed to a second station at which the cooled male mold is disposed between the first time period and the second time period.

In one or more of the various embodiments, a shuttle that carries the female mold may be raised from a first elevation to a second elevation. In some of the various embodiments, the female mold may be moved between the first time period and the second time period with the shuttle at the second elevation from a first station at which the heated male mold is disposed to a second station at which the cooled male mold is disposed. In some embodiments, the shuttle may be lowered from the second elevation to the first elevation with the female mold positioned at the second station.

In one or more of the various embodiments, the material in the female mold may be compressed with a second cooled male mold during a third time period, the third time period being after the first time period and before the second time period.

### DETAILED DESCRIPTION

The various embodiments now will be described more fully hereinafter with reference to the accompanying drawings, which form a part hereof and show, by way of illustration, specific example embodiments by which the invention may be practiced. The embodiments may, however, be embodied in many different forms and should not be construed as limited to the embodiments set forth herein; rather, these embodiments are provided so that this disclosure will be thorough and complete and will fully convey the scope of the embodiments to those skilled in the art. Among other things, the various embodiments may be methods, systems, or devices. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” refers to a grammatical conjunction to indicate that one or more of the connected terms may be employed. For example, the phrase “one or more A, B, or C” is employed to discretely refer to each of the following: i) one or more As, ii) one or more Bs, iii) one or more Cs, iv) one or more As and one or more Bs, v) one or more As and one or more Cs, vi) one or more Bs and one or more Cs, and vii) one or more As, one or more Bs, and one or more Cs. The term “based on” is not exclusive and allows for being based on additional factors not described, unless the context clearly dictates otherwise. In addition, the meaning of “a,” “an,” and “the” include plural references. Also, plural references are intended to also disclose the singular, unless the context clearly dictates otherwise. The meaning of “in” includes “in” and “on.” Also, the use of “when” and “responsive to” do not imply that associated resultant actions are required to occur immediately or within a particular time period. Instead, they are used herein to indicate actions that may occur or be performed in response to one or more conditions being met, unless the context clearly dictates otherwise.

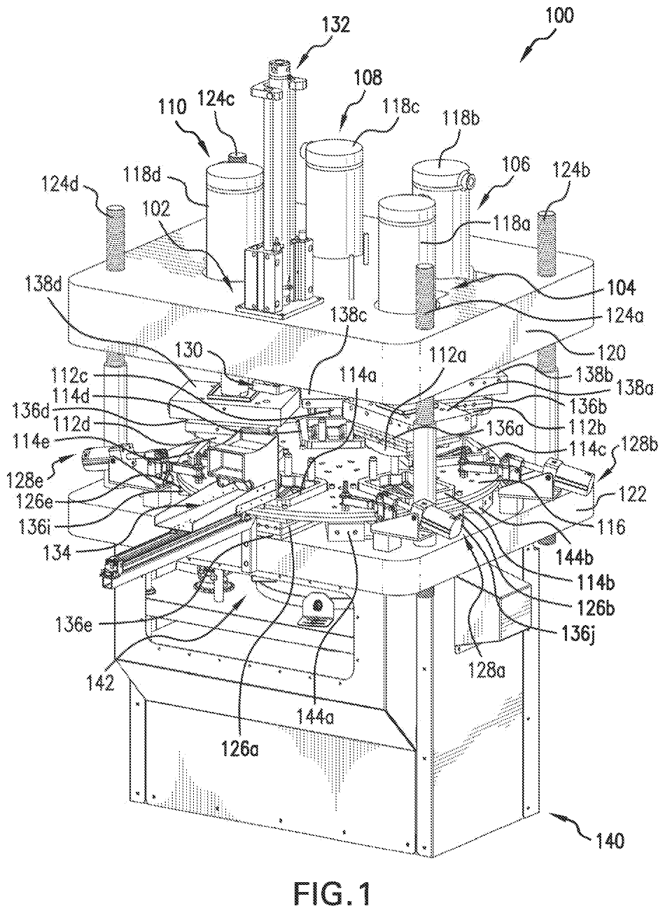

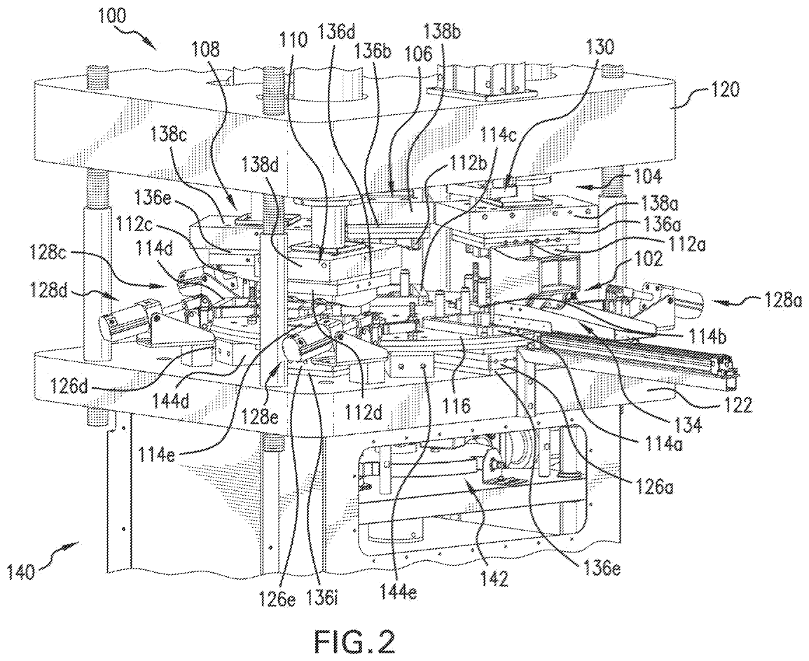

FIG. 1 is an isometric view of example compression molding apparatus 100, with hoses removed for ease of viewing other components of compression molding apparatus 100. FIG. 2 is an isometric view of a portion of compression molding apparatus 100 from another angle to show more components of compression molding apparatus 100, with hoses removed for ease of viewing other components of compression molding apparatus 100. Compression molding apparatus 100 facilitates molding multiple products in parallel while each of the products is in a different manufacturing phase by rotating the products through multiple stations in compression molding apparatus 100. Compression molding apparatus 100 also may facilitate faster manufacturing of products (such as UHMW PE) than typical direct compression molding (“DCM”) techniques (for example, providing a completed UHMW product every two minutes, compared to typical DCM techniques providing 1-4 finished UHMW products every 32 minutes) at least because compression molding apparatus 100 has at least one station that is dedicated to heated compression and at least one station that is dedicated to cooled compression, thereby eliminating the requirement in typical DCM techniques to heat a cooled mold and subsequently cool the heated mold for each product. Compression molding apparatus 100 further may facilitate more precise manufacturing of products than typical DCM techniques at least because some examples of compression molding apparatus 100 have at least two cooling stations to facilitate slowing a rate at which the products are cooled, thereby shrinking the products with greater precision. Compared to typical DCM techniques, compression molding apparatus 100 also may facilitate greater longevity and lower maintenance of mold components and facilitate using less raw material to manufacture a given product, as further discussed below. When referring to “raw” materials herein, the material is simply the feed material for the process, not necessarily virgin pure material from a first source. For example, the material may be recycled material. Greater longevity of the molds may be due to reduced heating and cooling of the individual molds. The molds in the current disclosed device are able to undergo less drastic temperature changes since at least some portions of the molds are consistently used in heating and some are consistently used in cooling instead of cycling between cooling and heating.

In the example shown in FIG. 1, compression molding apparatus 100 has five stations: loading/unloading station 102; heating station 104; heating station 106; cooling station 108; and cooling station 110. Four of the stations have temperature-regulated molds (for example, heated upper molds 112a and 112b and cooled upper molds 112c and 112d). Five carrying molds (for example, lower molds 114a-e) disposed in a DCM rotary shuttle 116 carry the products (such as UHMW parts) through the phases of the manufacturing process by moving from one station to the next as rotary shuttle 116 rotates. Hydraulic presses 118a-118d press the corresponding temperature-regulated molds toward the carrying molds when rotary shuttle 116 delivers the carrying molds to the next stations for compression of the products. The hydraulic presses are coupled to elevated table 120, which is supported above lower table 122 by adjustable columns 124a-124d, which facilitate leveling and adjusting the height of elevated table 120 relative to lower table 122.

Each station may have a block, such as lower block 126a, lower block 126b, a lower block (not shown) of station 106, lower block 126d (see FIG. 2), or lower block 126e, disposed below the carrying-mold position of the station. The blocks of the stations having temperature-regulated upper molds may be temperature-regulated heating or cooling blocks. For example, heating stations 104 and 106 have heated lower blocks (not shown for heating station 106), and cooling stations 108 and 110 may have cooled lower blocks. Lower block 126a of loading/unloading station 102 may be a heated lower block to facilitate pre-heating carrying molds at station 102 prior to transitioning to the first heating station.

One or more shuttle anchors (for example, shuttle anchors 128a-128e, with shuttle anchors 128c and 128d shown in FIG. 2) may be disposed on table 122 to temporarily hold rotary shuttle 116 in place when the carrying molds are aligned with their intended positions at each station. The one or more shuttle anchors may release rotary shuttle 116 after completion of each phase to facilitate shuttle 116 rotating to bring each carrying mold to the next station. As shown in FIG. 1, the shuttle anchors include hydraulic pistons that pivot forks toward the upper surface of rotary shuttle 116, with the distal ends of the forks having downward extending members with flat lower surfaces that temporarily press against the upper surface of rotary shuttle 116 to hold rotary shuttle 116 in place.

A product unloader may be disposed at load/unload station 102 to remove completed products from the lower molds when they arrive at load/unload station 102. In the example of FIG. 1, product unloader 130 includes one or more vacuum heads that lift completed products from carrying molds positioned at station 102 when extender 132 lowers product unloader 130 to bring the one or more vacuum heads into contact with a completed product and subsequently raises product unloader 130 with the completed product.

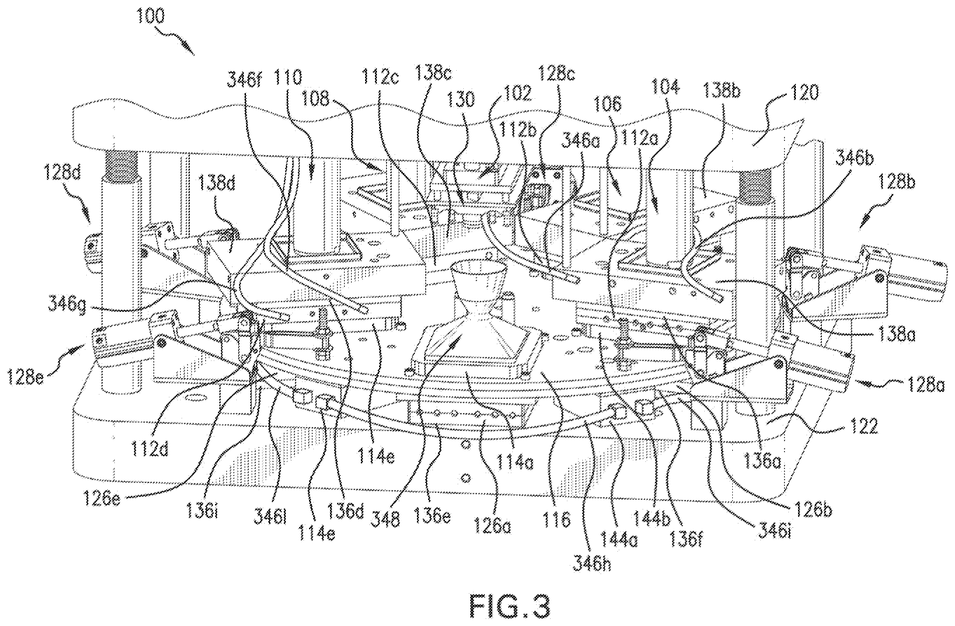

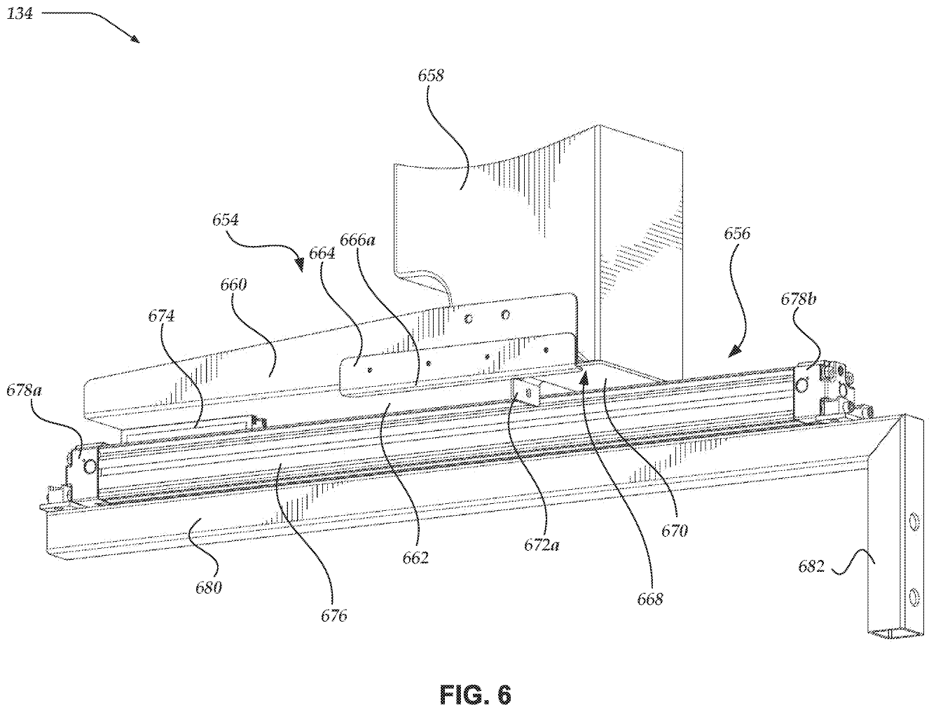

A slide dump assembly (for example, slide dump assembly 134) may be disposed at load/unload station 102 to automatically fill a carrying mold positioned at station 102 with raw material granules. Slide dump assembly 134 is further discussed with respect to FIGS. 6-8. The lower molds also may be manually filled with granules (see, for example, funneled distributor 348 in FIG. 3).

One or more isolation plates may thermally isolate one or more components of compression molding apparatus 100 from one or more other portions of compression molding apparatus 100. In the example shown in FIG. 1, isolation plates 136a-d (see FIG. 2 for isolation plate 136c) are disposed between the temperature-regulated molds and the mounting blocks at the distal end of the hydraulic presses of the corresponding stations, such as mounting blocks 138a-d (see FIG. 2 for mounting block 138c), to thermally isolate the temperature-regulated molds and the hydraulic presses from each other. Each station may have an isolation plate, such as isolation plate 136e, isolation plate 136f (see FIG. 3), an isolation plate of heating station 106 (not shown), isolation plate 136h (see FIG. 2), and isolation plate 136i, disposed between the lower block of the station and lower table 122 to thermally isolate the lower table from the lower heating and cooling blocks. Each isolation plate may be made from an insulation material or may have coolant running through the isolation plate to maintain a constant temperature.

Lower table 122 may be disposed on a base, such as base 140. In the example of FIG. 1, base 140 houses control components 142. Control components 142 also may include one or more computer components that are programmed to control the operation of compression molding apparatus 100. Control components 142 may include a pneumatic cylinder or hydraulic lift to lift rotary shuttle 116 prior to rotating rotary shuttle 116 and to lower rotary shuttle 116 when the carrying molds arrive at the next stations. Control components 142 also may include one or more motors to rotate rotary shuttle 116 and isolation plate. Control components 142 further may include one or more cooling or heating systems to cool or heat fluid and one or more pumps to pump the cooled or heated fluid through temperature-regulated components, such as temperature-regulated molds or isolation plates. In some examples, one or more transfer blocks may be disposed between each station, such as transfer block 144a, transfer block 144b, a transfer block between stations 106 and 108 (not shown), transfer block 144d, and transfer block 144e, and may transfer cooled or heated fluid between one or more cooling or heating systems and one or more temperature-regulated components disposed on lower table 122. Temperature-regulated components that are coupled to the hydraulic presses may be coupled to one or more cooling or heating systems that are disposed on elevated table 120.

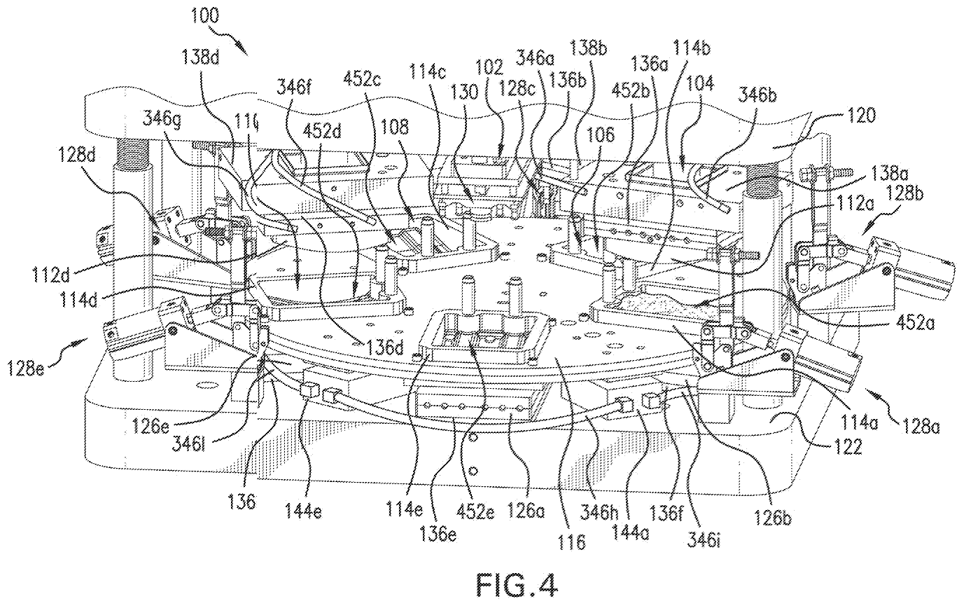

FIG. 3 is an isometric view of a portion of compression molding apparatus 100 in a compression configuration, with raw material granules being loaded into lower mold 114a at loading/unloading station 102. In the compression configuration, each of the upper molds are pressed against UHMW material in the carrying molds positioned at the stations having the upper molds. When rotary shuttle 116 stops with the carrying molds positioned at the stations of the next stages of the manufacturing process for the respective carrying molds, a lifting control component (for example, a shuttle elevator, such as a pneumatic cylinder or a hydraulic lift) may lower rotary shuttle 116 to bring the bottom surfaces of the carrying molds into contact with the upper surfaces of the lower blocks, such as heated lower block 126a, heated lower block 126b, the cooled lower block (not shown) of station 106, cooled lower block 126d (see FIG. 2), or cooled lower block 126e. The shuttle anchors may then transition from an unanchored configuration (see FIG. 4) to an anchored configuration in which the flat lower surfaces of the downward extending members of the shuttle anchors press downward against the top surface of rotary shuttle 116 to hold rotary shuttle 116 in place. Each of the upper molds are then lowered to press against UHMW material in the carrying molds positioned at the stations having the upper molds to bring compression molding apparatus 100 into the compression configuration.

In the example of FIG. 3, UHMW granules are loaded into lower mold 114a. Previously loaded UHMW granules are compressed between upper mold 112a and lower mold 114b at first heating station 104. A UHMW product that has undergone the manufacturing phase of station 104 is compressed between upper mold 112b and lower mold 114c at second heating station 106. A UHMW product that has undergone the manufacturing phases of stations 104 and 106 is compressed between upper mold 112c and lower mold 114d at first cooling station 108. A UHMW product that has undergone the manufacturing phases of stations 104-108 is compressed between upper mold 112d and lower mold 114e at second cooling station 110.

FIG. 3 also shows example hoses transporting cooled or heated fluid to various temperature-regulated components, such as coolant hose 346a bringing cooled fluid to mounting block 138a, coolant hose 346b bringing cooled fluid from mounting block 138a to mounting block 138b, a coolant hose bringing cooled fluid from mounting block 138b to a cooling system (not shown), coolant hoses bringing cooled fluid to and from cooled upper mold 112c (not shown), coolant hose 346f bringing cooled fluid to cooled upper mold 112d, and coolant hose 346g bringing cooled fluid from cooled upper mold 112d to a cooling system (not shown). The transfer blocks also may be connected to each other with hoses, such as coolant hoses 346h, 346i, 3461, and other hoses (not shown). Heated fluid also may be transferred to and from the heated upper molds with hoses (not shown). Cooled or heated fluid further may be transferred to and from the temperature-regulated lower blocks with hoses (not shown).

In the example shown in FIG. 3, funnel distributor 348 includes an upper funnel portion and internal tubular paths that distribute UHMW granules poured into the upper funnel portion to various portions of the carrying mold positioned at loading/unloading station 102 to facilitate manual loading of the carrying molds. In other examples, an automated system may be used to load the carrying molds, such as slide dump assembly 134 (see FIGS. 1, 2, and 6-8).

FIG. 4 is an isometric view of a portion of compression molding apparatus 100 in a transition configuration. In the transition configuration, each of the upper molds are separated and spaced apart from the UHMW material in the carrying molds. When the manufacturing stages of each of the stations are complete, the hydraulic presses lift the upper molds away from the carrying molds. The shuttle anchors may then transition from the anchored configuration (see FIG. 3) to the unanchored configuration in which the flat lower surfaces of the downward extending members of the shuttle anchors are separated and spaced apart from the top surface of rotary shuttle 116. The lifting control component (for example, the shuttle elevator) may raise rotary shuttle 116 to bring the bottom surfaces of the carrying molds out of contact with the upper surfaces of the lower blocks, such as heated lower block 126a, heated lower block 126b, the cooled lower block (not shown) of station 106, cooled lower block 126d (see FIG. 2), or cooled lower block 126e. Rotary shuttle 116rotate to move each carrying mold to the next station.

In the example of FIG. 4, raw material granules 452a are moved from loading/unloading station 102 to first heating station 104, product 452b is moved from first heating station 104 to second heating station 106, product 452c is moved from second heating station 106 to first cooling station 108, product 452d is moved from first cooling station 108 to second cooling station 110, and completed product 452e is moved to loading/unloading station 102.

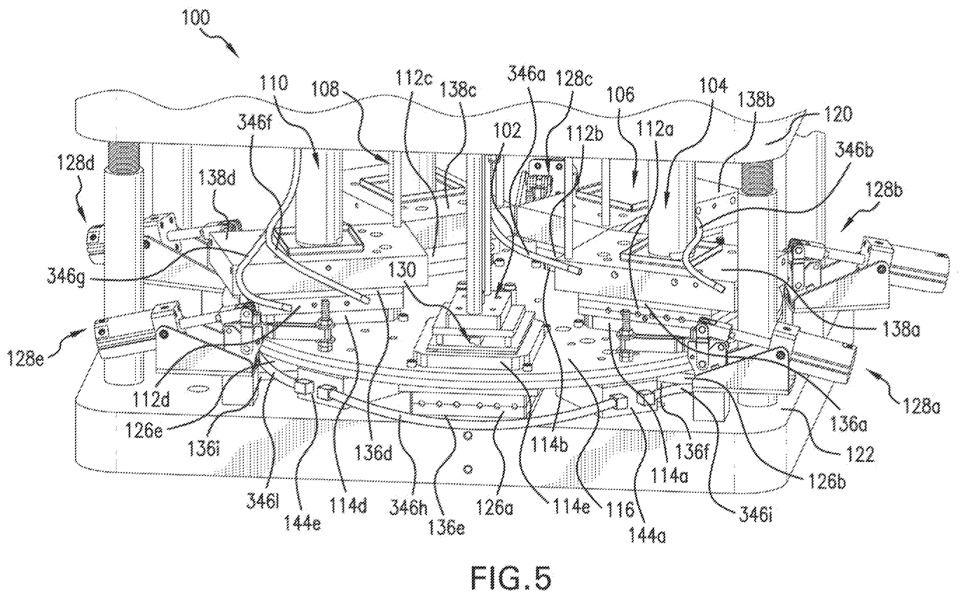

FIG. 5 is an isometric view of a portion of compression molding apparatus 100 in the compression configuration, with product unloader 130 lowered to secure completed product 452e at loading/unloading station 102 for removal. Product unloader 130 may then be raised while lifting completed product 452e. After removal of completed product 452e, raw material granules may be loaded into lower mold 114e as described with respect to FIG. 3. When the manufacturing stages of each of the stations are complete, compression molding apparatus 100 may transition to the transition configuration and rotary shuttle 116 rotated to bring each carrying mold to the next station as described with respect to FIG. 4. These steps may be repeated to continue manufacturing products.

In some examples, the hydraulic presses may include 30-ton hydraulic presses (the typical DCM process employs 200-ton hydraulic presses). With a UHMW PE product, examples of pressures and temperatures employed at each station having an upper mold include the following: i) first heating station 104 may employ a high-pressure top force of 2,300 psi and a mold or heated-liquid temperature of 280° F. (slightly over the molten temperature of UHMW PE material); ii) second heating station 106 may employ a low-pressure top force of 500-600 psi and a mold or heated-liquid temperature of 330° F.; iii) first cooling station 108 may employ a high-pressure top force of 1,500-2,300 psi and a coolant temperature of 40-85° F.; and iv) second cooling station 108 may employ a high-pressure top force of 1,500-2,300 psi and a coolant temperature of 40-85° F. In some examples, each station operates under these conditions for 2 minutes. In other examples, different stations may operate for different amounts of time or may vary one or more conditions. For example, the first cooling station may employ a coolant temperature of 40° F. with the coolant flowing continuously for two minutes, and the second cooling station may employ a coolant temperature of 85° F. with the coolant flowing for less than the phase duration of two minutes (for example, 1 minute). To ensure a proper heat soak and cooling, the pressures, temperatures, and timing may depend on the size of the product being molded, including the thickness of the product.

Because the upper male molds and the lower female molds in the typical direct compression molding (“DCM”) process are heated and cooled in a manufacturing cycle of a UHMW product, the male and female molds break down quickly in the typical DCM process. The typical DCM process requires aluminum male molds and steel female molds to facilitate the male mold expanding to seal with the female mold. In contrast, because the upper male molds of the present disclosure are either heated or cooled (not both) in compression molding apparatus 100, the longevity of the upper male molds is significantly greater than the longevity of the upper male molds in the typical DCM process; and expansion of the upper male molds is not required to form a seal with the carrying female molds. Accordingly, the upper male molds and the carrying female molds may include either aluminum or steel (for example, steel upper male molds and aluminum carrying female molds). Employing aluminum female carrying molds facilitates faster cooling of the female carrying molds and the carried UHMW or other material.

In the typical DCM process, significant amounts of UHMW material escapes from between compressed molds, producing significant amounts of flash that requires trimming. The escaped UHMW material also sticks to the molds, making demolding difficult and requiring ejector pins in the molds. To the contrary, the molding process with compression molding apparatus 100 produces relatively little flash. Accordingly, less raw material is required, demolding is easier (no ejector pins are necessary), and the molds are less likely to become plugged. In some examples, compression molding apparatus 100 has one or more air poppet valves in the bottom surface of one or more of the upper male molds (for example, upper mold 112b of second heating station 10) to prevent the products at those one or more corresponding stations from sticking to the one or more upper male molds. Because the UHMW material moved with variations in the temperature in the typical DCM process, employing air poppet valves was impractical because the air poppet valves would have clogged.

Other preferred methods of maintain consistent release of the product from the molds includes spraying a mold release into the bottom of the female mold prior to loading raw material into the mold. Mold release may also be sprayed on the bottom of the male mold or on the top of the product after the first heating stage. Injection spray nozzles, such as fuel injector nozzles may be employed for spraying such mold release liquid.

Because the temperature-regulated components in the typical DCM process were each heated and subsequently cooled in a manufacturing cycle of a UHMW product, the coolant typically steamed out and provided a temperature shock on its initial return to the cooling system. Because the main temperature-regulated components of compression molding apparatus 100 are either heated or cooled (not both), there is less (if any) coolant lost to steam and shock to the cooling system. The coolant may include antifreeze or oil. The heated liquid may include heated oil. In other examples, heated components may employ resistive heating.

FIG. 6 is an isometric side view of example slide dump assembly 134 for loading UHMW granules into a lower carrying female mold at loading/unloading station 102 of compression molding apparatus 100, with slide dump assembly 134 in a retracted configuration. In the retracted configuration, slidable dump 654 is disposed at the distal end portion of mounted slide 656 so that, when mounted on compression molding apparatus 100, slidable dump 654 does not interfere with moving components of compression molding apparatus 100.

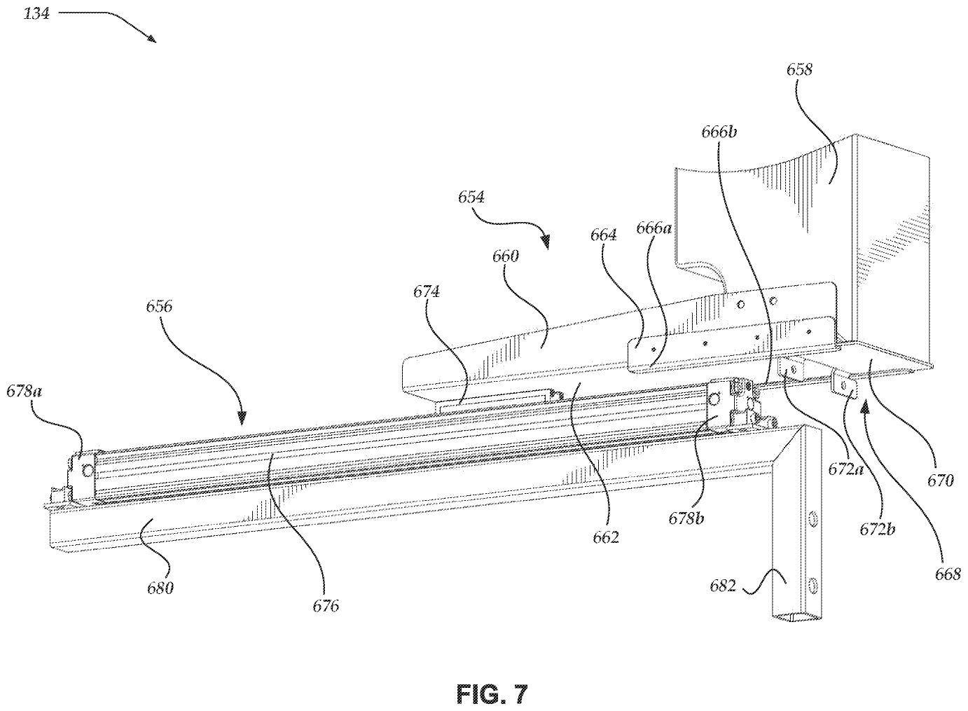

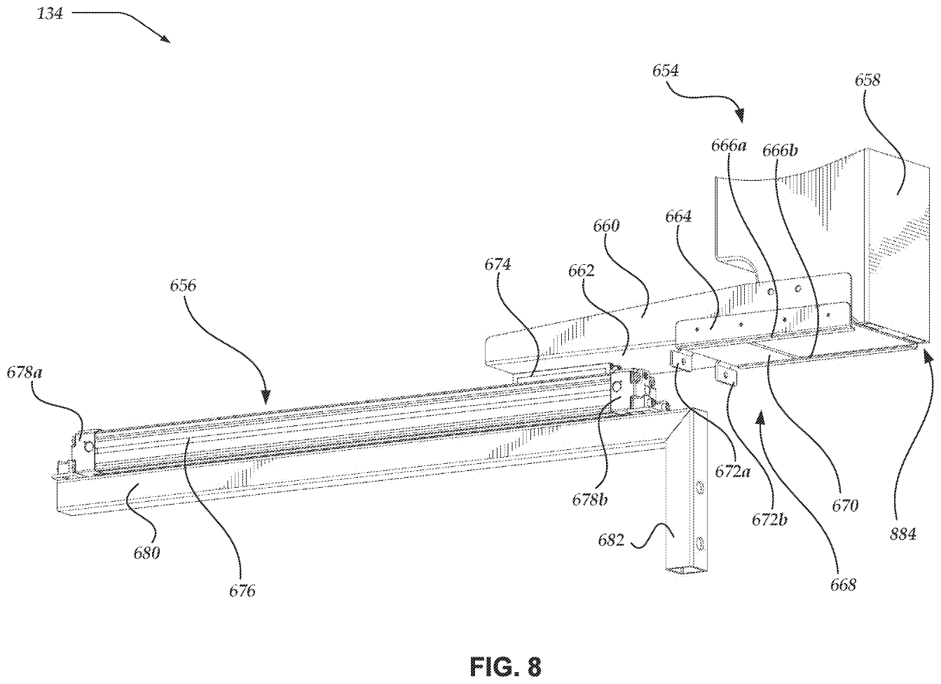

Slidable dump 654 may include bed 658 that holds UHMW granules that are loaded into bed 658 by pouring the granules into the open top of bed 658 (see the open top in FIGS. 1 and 2). Bed 658 may be coupled to one or more portions of a dump frame, such as side wall 660 or floor 662. The dump frame may have one or more tracks or channels to facilitate one or more components sliding between closed and open configurations to prevent or allow flowing of raw material granules out of the bottom of bed 658. In the example of FIG. 6, angle irons are mounted to the dump frame, with vertical portion 664 (see FIG. 2 for the vertical portion of the other angle iron) being coupled to side wall 660 and lateral portions 666a and 666b (see FIGS. 7 and 8 for lateral portion 666b) being parallel to and spaced apart from floor 662. Lateral portions 666a and 666b, together with floor 662 of the dump frame, define tracks or channels along which gate 668 may slide. Gate 668 may include door 670 and one or more tabs, such as tabs 672a and 672b (see FIGS. 7 and 8 for tab 672b). Gate 668 may be biased to the closed configuration and may transition to the open configuration when the one or more tabs are pushed toward the distal end portion of mounted slide 656. Slider 674 may slidably couple slidable dump 654 to mounted slide 656.

Mounted slide 656 may include drive 676 that moves slidable dump 654 by driving slider 674 along mounted slide 656. Examples of drive 676 include a linear air slide or a worm drive with controllable speed and direction. The distal end portion of drive 676 may have distal couplers 678a, and the proximal end portion of drive 676 may have proximal coupler 678b. Couplers 678a and 678b may mount drive 676 to longitudinal beam 680 of mounted slide 656. Proximal mount 682 may be coupled to beam 680 and may be coupled to compression molding apparatus 100 to mount slide dump assembly 134 at loading/unloading station 102.

FIG. 7 is an isometric view of slide dump assembly 134 in an impact configuration, as also shown in FIG. 1. In the impact configuration, tabs 672a and 672b contact one or more portions of compression molding apparatus 100 at loading/unloading station 102, such as the radially outer face of the carrying mold at loading/unloading station 102, and gate 668 is in the closed configuration. Accordingly, in the example of FIGS. 1 and 2, the impact configuration occurs when drive 676 moves slidable dump 654 toward the radially inner portion of the carrying mold at the point where tabs 672a and 672b initiate contact with the radially outer face of the carrying mold at loading/unloading station 102.

FIG. 8 is an isometric view of slide dump assembly 134 in a loading configuration. In the loading configuration, gate 668 is disposed in the same position relative to mounted slide 656 as in the impact configuration, and the remainder of slidable dump 654 continues to move toward the radially inner portion of the carrying mold at loading/unloading station 102, with opening 884 exposed (unexposed in the impact and retracted configurations, as shown in FIGS. 6 and 7). Door 670 has a longitudinal length that prevents opening 884 from being exposed until opening 884 is positioned over the cavity of the carrying female mold. Drive 676 is configured (mechanically or programmatically) to move opening 884 to the distal end portion of the cavity and back to the impact configuration, where gate 668 again covers opening 884. Drive 676 is also configured (mechanically or programmatically) to control the amount of raw material granules that are dropped through opening 884 from bed 658 into the cavity by varying the speed of drive 676. Accordingly, drive 676 may move slower for deeper cavities or cavity portions and may move faster for shallower cavities or cavity portions. Slide dump assembly 134 facilitates improving uniformity of raw material distribution in carrying female molds, at least in comparison to manual loading.

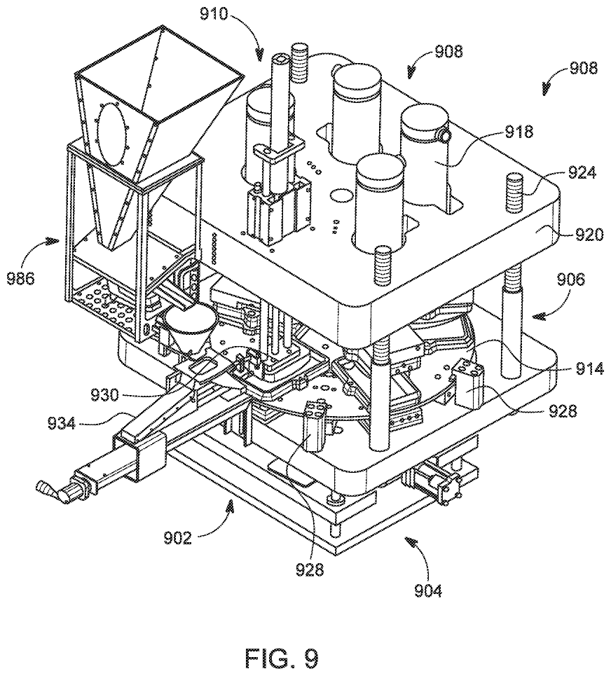

A slightly different embodiment is illustrated in FIGS. 9 through 14. Throughout these figures the numbering is consistent for the last two digits for similar parts whereas the first digit is a 9 to distinguish the embodiment from the others (e.g., 902, 904, etc.). The basics are mostly the same between embodiments, thus, the following description focuses on the differences.

The molding apparatus 900 of FIG. 9 shows a feed assembly 986 with a slide dump assembly 934. The apparatus also utilizes different shuttle anchors 928. Shuttle anchors 928 are fixed blocks with overhangs that are spaced about .25 inches above the plate upper surface of shuttle 916. This allows the shuttle 916 to lift slightly before contacting shuttle anchors 928 to rotate the lower molds 914 to the next station while also providing a stop to the shuttle 916 in case of an upper mold not initially releasing from a lower mold. In a preferred method of carrying out the separation of the upper molds from the lower molds, one mold at a time is pulled upwardly by the presses 918 with an initial lift of less than the distance to the shuttle anchor overhang/stop. Once all upper molds are slightly lifted with initial release, they are all pulled together to engagement of the shuttle 916 with the stop blocks as necessary for final separation of the molds with each product being molded remaining in its lower mold cavity. Measuring devices, such as lasers, may be employed to verify proper separation at each step before attempting to move on. Once the upper molds are fully separated, the lower molds with the products are rotated with the shuttle 916 to the next station.

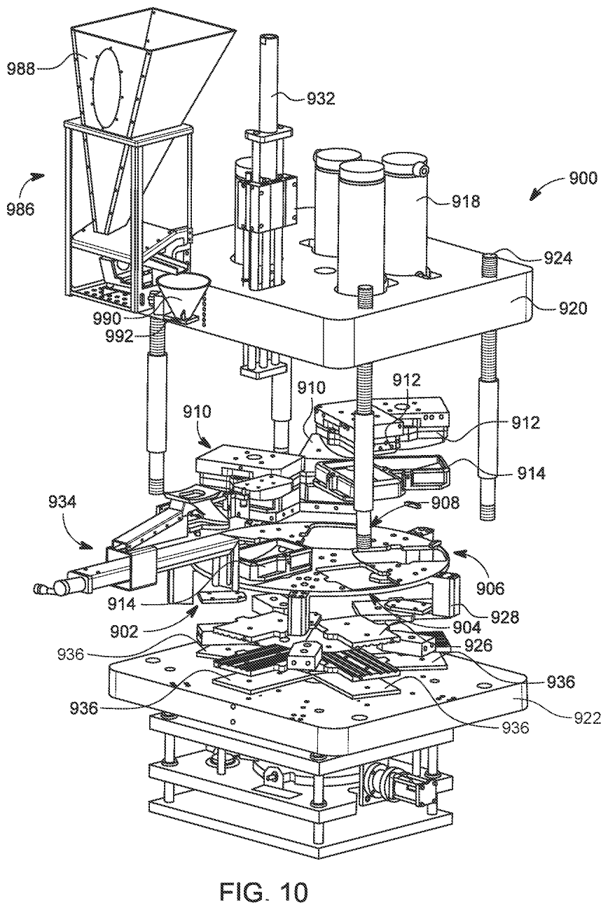

The exploded view of FIG. 10 illustrates the parts of the molding apparatus 900 with some clarity. Feed assembly 986 includes a hopper 988 for delivering raw material granules. Hopper 988 may be fed with an automated delivery system or may be hand filled. Hopper delivers granules to a funnel 990 that is positioned over the slide dump assembly 934. A delivery gate 992 on the bottom of funnel 990 meters the amount of material delivered to dump assembly 934.

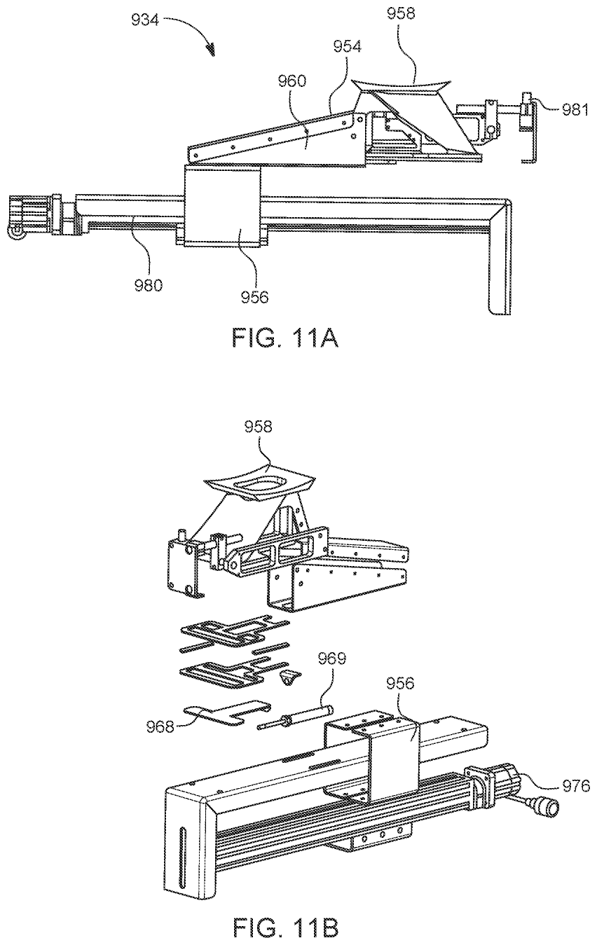

Slide dump assembly 934 is illustrated in more detail in FIGS. 11A-B. A bed 958 is provided with a center opening to receive the raw material granules into a chute for delivery to a lower mold. The bed 958 also functions to hold a completed product P and deliver it out of the molding apparatus 900. The bottom of the chute is opened and closed with a gate 968 that is controlled with an actuator 969. Actuator 969 is preferably a linear actuator that is air driven to move a plate to block or open the opening at the bottom of the chute. In the example here, the gate is T-shaped with the cross portion of the T interfacing with the opening for closure. The drive 976 moves the mounted slide and the bed and chute from the fill station below the funnel 990 to a position above a lower mold to deliver shots of material to the lower mold. The actuator may be programmed to deliver a shot of material (e.g., 50 grams) to a particular location in the mold. The slide dump assembly may thus deliver multiple loads to differing areas of the lower mold to disperse the raw material granules across the lower mold as needed for a consistent press and depending on the size and thickness of the mold and product being molded.

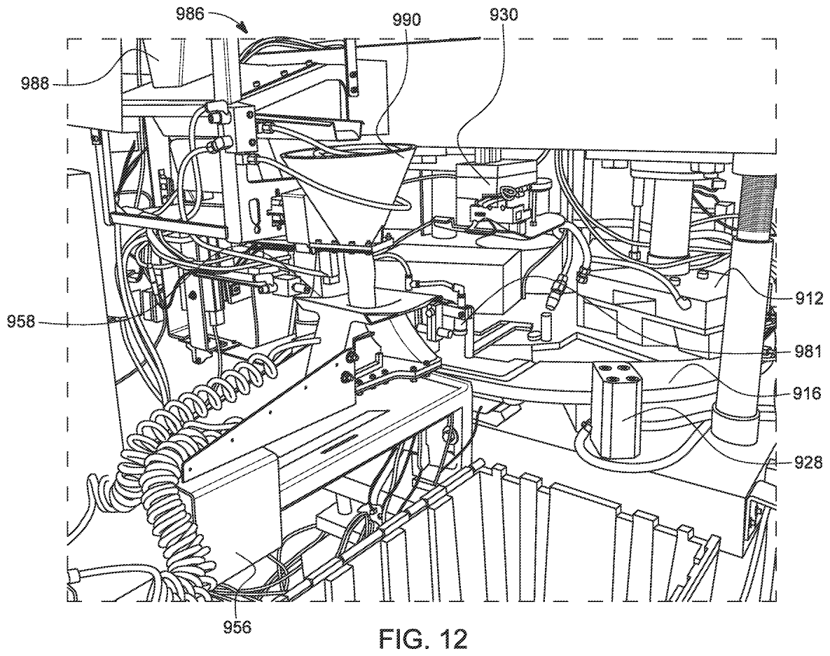

The initial granule feed process is also shown in FIG. 12. In this view the granules are being dumped through the opening in the bed 958 into the chute with the gate closed. Once the predetermined amount of raw material is delivered to the chute, the slide dump assembly is moved over a lower mold in the first/loading station and the gate is opened to deliver raw material to the lower mold. This may occur multiple times to deliver discrete loads of raw material granules to different locations in the lower mold. FIG. 12 also illustrates an air tube to blow air into the funnel to release any deposits of granules in the funnel. Air nozzles may also be employed near the lower molds to blow away any loose flashing material or granular resin from around the molds.

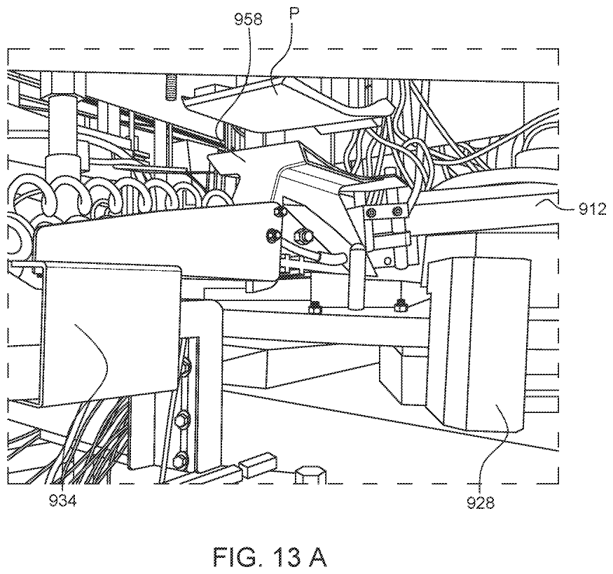

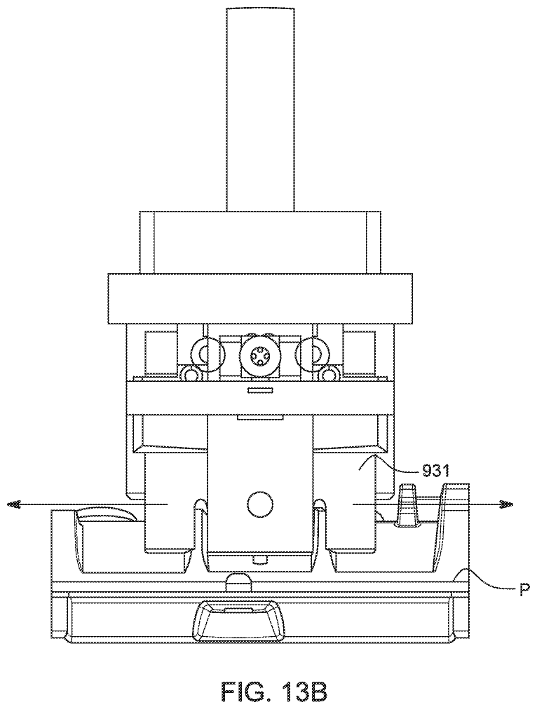

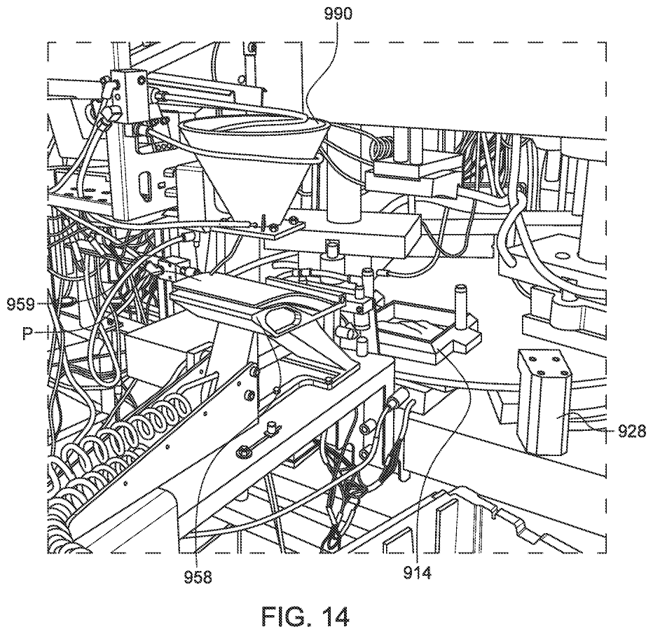

Note the product P held above the bed 958 in FIG. 13A. After a delivery of a load of material through the chute into the lower mold, a gripper 931 (see FIG. 13B) may release the part molded from the previous station onto the top of the bed 958. Gripper 13B includes air actuated jaws for clamping against a portion of the product P. If the product design does not include a fin for gripping, one or more can be added for this purpose and machined away later. Thus, with the product P released onto the bed 958, retraction of the slide dump assembly brings the product P back outside of the shuttle area where it can be ejected from the assembly as shown in FIG. 14. A part ejector 959 may be used to bump product P off of bed 958 and into a bin, for example.

FIGS. 12-14 also show a sprayer 981 that is configured to spray mold release onto the bottom of the lower mold before raw material granules are deposited into the mold. Mounting the sprayer onto the leading end of the slide dump assembly positions the sprayer to be moved over the mold. A sprayer may be made similar to a fuel injector, for example, to spray mold release liquid. Similar sprayers may be used to spray the bottom of an upper mold or the top of a product P after mold opening at any of the stations. Mold release is preferably sprayed on the top of the product P after the mold opens at the first heating/compression station.

The apparatus and process employed herein greatly increases the speed of production of products P while extending the life of the molds. Both benefits accrue in part due to the process keeping the heating mold hot and the main cooling molds cool instead of fully heat soaking then cooling within a single male-female mold assembly. In the preferred embodiments here, the upper molds are either hot or cold and remail so with smaller fluctuations. These upper molds are preferably steel, which tends to hold the heat well. The lower molds are preferably aluminum for quick heating and cooling, depending on the station. These are the only portions of the process that are both heated and cooled with the product. Thus, the station times are minimized with a product exiting the assembly every eight to ten minutes, depending on the product size.

The embodiments here are shown with five stations, one loading/unloading station, two heating stations, and two cooling stations. However, more stations may be employed, as desired for more gradual heating or cooling. Fewer stations may also be employed, such as a single heating station or a single cooling station. Heating and cooling are preferably accomplished with heating and cooling liquids channeled through the various heating and cooling plates. Alternative methods of heating and cooling may be employed, such as resistance heating. The heating and cooling liquids themselves may also change, such as water-based or oil based liquids.

The foregoing examples should not be construed as limiting or exhaustive, yet rather, illustrative use cases to show implementations of at least one of the various embodiments of the invention. Accordingly, many changes can be made without departing from the spirit and scope of the invention. For example, although the figures show two heating stations and two cooling stations, more or fewer of one or the other may be employed. As another example, the male molds may move while the female molds remain stationary. Thus, the scope of the invention is not limited by the disclosure of the examples. Instead, the invention should be determined entirely by reference to the claims that follow.

The embodiments of the invention in which an exclusive property or privilege is claimed are defined as follows:

1. A compression molding apparatus, comprising:
a first mold that carries a moldable material;
a heated second mold that compresses the moldable material in the first mold during a first time period; and
a cooled third mold that compresses the UHMW material in the first mold during a second time period.

2. The compression molding apparatus of claim 1, further comprising a shuttle that moves the first mold between the first time period and the second time period from a first station at which the heated second mold is disposed to a second station at which the cooled third mold is disposed.

3. The compression molding apparatus of claim 1, further comprising:
a shuttle that moves the first mold between the first time period and the second time period from a first station at which the heated first mold is disposed to a second station at which the cooled third mold is disposed; and
a shuttle elevator that raises the shuttle from a first elevation to a second elevation at which the shuttle is disposed while moving the first mold to the second station and that lowers the shuttle from the second elevation to the first elevation when the first mold is positioned at the second station.

4. The compression molding apparatus of claim 1, further comprising a heated fourth mold that compresses the moldable material in the first mold during an intermediate third time period, the third time period being after the first time period and before the second time period.

5. The compression molding apparatus of claim 1, further comprising a heated fifth mold that compresses the moldable material in the first mold during a third time period, the third time period being after the first time period and before the second time period, the heated fifth mold compressing the moldable material with a different pressure or temperature than the heated second mold.

6. The compression molding apparatus of claim 1, further comprising a cooled fourth mold that compresses the moldable material in the first mold during a third time period, the third time period being after the first time period and before the second time period.

7. The compression molding apparatus of claim 1, wherein the heated second mold has an air poppet valve.

8. The compression molding apparatus of claim 1, wherein the cooled third mold compresses the moldable material in the female mold for 10, 5, 4, 3, 2, or fewer minutes.

9. The compression molding apparatus of claim 1, wherein the heated second mold and the cooled fourth mold are devoid of ejector pins. The compression molding apparatus of claim 1, wherein the heated second mold includes steel.

10. The compression molding apparatus of claim 1, further comprising a slide dump assembly, the slide dump assembly having a bed that holds moldable material granules and that slides over the first mold while depositing granules in the first mold.

11. The compression molding apparatus of claim 11, further comprising a spray nozzle secured to the slide dump assembly.

12. The compression molding apparatus of claim 11, wherein delivery of the granules is controlled by a gate that is actuator driven.

13. The compression molding apparatus of claim 1, further comprising a mold release spray nozzle adjacent at least one of the molds.

14. The compression molding apparatus of claim 1, further comprising a slide dump assembly, the slide dump assembly having:
a bed having a lower opening and holding moldable material granules;
a gate that transitions between blocking and unblocking the lower opening; and
a drive that moves the bed from a retracted configuration to a loading configuration, the lower opening of the bed in the loading configuration being disposed over the first mold, and the gate blocking the lower opening in the retracted configuration and unblocking the lower opening in the loading configuration to facilitate the granules flowing through the lower opening into the first mold when the bed is in the loading configuration.

15. The compression molding apparatus of claim 1, further comprising a slide dump assembly, the slide dump assembly having:
a bed having a lower opening and holding molding material granules;
a gate that transitions between blocking and unblocking the lower opening, the gate being biased to blocking the lower opening, and the gate having a tab; and
a drive that moves the bed from a retracted configuration to a loading configuration, the lower opening of the bed in the loading configuration being disposed over the first mold, and the gate blocking the lower opening in the retracted configuration, the tab of the gate contacting a component of the compression molding apparatus when the bed is in the loading configuration and causing the gate to unblock the lower opening to facilitate the granules flowing through the lower opening into the first mold when the bed is in the loading configuration.

16. A compression molding apparatus, comprising:
a female mold;
a slide dump assembly, the slide dump assembly having a bed that holds moldable material granules and that slides over the female mold while depositing the granules in the female mold; and
an opposing mold that compresses the granules in the female mold.

17. The compression molding apparatus of claim 16, wherein the bed has a lower opening and the slide dump assembly further has:
a gate that transitions between blocking and unblocking the lower opening; and
a drive that moves the bed from a retracted configuration to a loading configuration, the lower opening of the bed in the loading configuration being disposed over the female mold, and the gate blocking the lower opening in the retracted configuration and unblocking the lower opening in the loading configuration to facilitate the granules flowing through the lower opening into the female mold when the bed is in the loading configuration.

18. The compression molding apparatus of claim 16, wherein the bed has a lower opening and the slide dump assembly further has:
a gate that transitions between blocking and unblocking the lower opening, the gate being biased to blocking the lower opening, and the gate having a tab; and
a drive that moves the bed from a retracted configuration to a loading configuration, the lower opening of the bed in the loading configuration being disposed over the female mold, and the gate blocking the lower opening in the retracted configuration, the tab of the gate contacting a component of the compression molding apparatus when the bed is in the loading configuration and causing the gate to unblock the lower opening to facilitate the granules flowing through the lower opening into the female mold when the bed is in the loading configuration.

19. A compression molding method, comprising:
Depositing moldable material into a female mold;
compressing the moldable material in the female mold with a heated opposing mold during a first time period; and
compressing the moldable material in the female mold with a cooled opposing mold during a second time period.

20. The compression molding method of claim 19, further comprising moving the female mold with a shuttle from a first station at which the heated opposing mold is disposed to a second station at which the cooled opposing mold is disposed between the first time period and the second time period.

21. The compression molding method of claim 19, further comprising:
raising a shuttle that carries the female mold from a first elevation to a second elevation;
moving the female mold between the first time period and the second time period with the shuttle at the second elevation from a first station at which the heated opposing mold is disposed to a second station at which the cooled opposing mold is disposed; and
lowering the shuttle from the second elevation to the first elevation with the female mold positioned at the second station.

22. The compression molding method of claim 19, further comprising compressing the moldable material in the female mold with a second cooled opposing mold during a third time period, the third time period being after the first time period and before the second time period.

23. The compression molding method of claim 19, further comprising spraying a mold release onto at least one of the molds.

24. The compression molding method of claim 19, further comprising spraying a mold release onto the moldable material between time periods.

25. The compression molding method of claim 19, further comprising compressing multiple molds concurrently.
